(19) United States
(12) Patent Application Publication
(10) Pub. No.: US 2022/0253921 A1
(43) Pub. Date: Aug. 11, 2022

(54) POINT-OF-SALE SYSTEMS FOR MATTRESSES, PILLOWS, AND BEDDING AND BEDROOM-RELATED PRODUCTS

(71) Applicant: Elements Group LLC, Mesquite, TX (US)

(72) Inventor: Josh Micklos, Mesquite, TX (US)

(73) Assignee: Elements Group LLC, Mesquite, TX (US)

(21) Appl. No.: 17/585,235

(22) Filed: Jan. 26, 2022

Related U.S. Application Data
(60) Provisional application No. 63/141,944, filed on Jan. 26, 2021.

(51) Int. Cl. G06Q 30/06; B65G 1/137; B65G 1/04; G06Q 10/08; G06Q 20/40

(52) U.S. Cl. CPC G06Q 30/0641; B65G 1/1371; B65G 1/0471; B65G 2203/0283; G06Q 20/401; B65G 2203/0216; G06Q 10/087

(57) ABSTRACT

Embodiments herein call for an apparatus, method, and system for the sale and provision to users of mattresses, pillows, and other bedding and bedroom-related products. The system comprising: a storage compartment configured to hold one or more units each of one or more products, wherein the one or more products are selected from pillows, mattresses, pillowcases, sheets, blankets, or comforters; at least one delivery compartment configured to receive at least one unit and permit extraction of the at least one unit by a user; a unit transfer subsystem configured to remove a selected at least one unit from the storage compartment and transfer the selected at least one unit to the delivery compartment; and a user interface configured to display the one or more products to a user, receive a user selection of one or more of the units, and authorize the unit transfer subsystem to transfer the selected at least one unit to the delivery compartment.

### FIELD OF THE INVENTION

Generally, the present disclosure relates to point-of-sale systems, and, more specifically, to systems for the sale and provision to users of mattresses, pillows, and other bedding- and bedroom-related products.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to system, comprising a storage compartment configured to hold one or more units each of one or more products, wherein the one or more products are selected from pillows, mattresses, pillowcases, sheets, blankets, or comforters; at least one delivery compartment configured to receive at least one unit and permit extraction of the at least one unit by a user; a unit transfer subsystem configured to remove a selected at least one unit from the storage compartment and transfer the selected at least one unit to the delivery compartment; and a user interface configured to display the one or more products to a user, receive a user selection of one or more of the units, and authorize the unit transfer subsystem to transfer the selected at least one unit to the delivery compartment.

In one embodiment, the present disclosure is directed to system, comprising a cylindrical housing, comprising a rotatable upper storage compartment configured to hold one or more units of a first product, and a rotatable lower storage compartment configured to hold one or more units of a second product, wherein the first product is selected from pillows, pillowcases, or sheets, and the second product is selected from mattresses, blankets, or comforters; an upper delivery compartment configured to receive at least one unit of the first product and permit extraction of the at least one unit of the first product by a user; a lower delivery compartment configured to receive at least one unit of the second product and permit extraction of the at least one unit of the second product by the user; an upper motor configured to rotate the upper storage compartment to position a selected at least one unit from the upper storage compartment in the upper delivery compartment; a lower motor configured to rotate the lower storage compartment to position a selected at least one unit from the lower storage compartment in the lower delivery compartment; and a user interface configured to display the one or more products to a user, receive a user selection of one or more of the units, and authorize the unit transfer subsystem to transfer the selected at least one unit to the delivery compartment.

In one embodiment, the present disclosure is directed to a method, comprising providing, to a user, an interface for selecting and purchasing one or more units each of one or more products selected from pillows, mattresses, pillowcases, sheets, blankets, or comforters; transferring, to the user or an agent of the user, an authorization token indicative of the user's selection and purchase of the one or more units; transferring, by unit transfer subsystem, the one or more units from a storage compartment configured to hold the one or more units to at least one delivery compartment configured to receive the at least one unit; permitting extraction of the at least one unit by a holder of the authorization token.

### BRIEF DESCRIPTION OF THE DRAWINGS

The disclosure may be understood by reference to the following description taken in conjunction with the accompanying drawings, in which like reference numerals identify like elements, and in which:

FIG. 1 presents a conceptual front view of components of a first system, in accordance with embodiments herein.

FIG. 2A presents a side cross-sectional view of some of the components of the system shown in FIG. 1 in a first conformation, in accordance with embodiments herein.

FIG. 2B presents a side cross-sectional view of the components of the system shown in FIG. 2B in a second conformation, in accordance with embodiments herein.

FIG. 3A presents a conceptual front view of some of the components of the system shown in FIG. 1 and additional components in a first conformation, in accordance with embodiments herein.

FIG. 3B presents a conceptual front view of the components of the system shown in FIG. 3A in a second conformation, in accordance with embodiments herein.

FIG. 4 presents a conceptual front view of components of a second system, in accordance with embodiments herein.

FIG. 5 shows a block diagram of components of a user interface compatible with the first and second systems, in accordance with embodiments herein.

FIG. 6 shows a block diagram of additional components usable in the first and second systems, in accordance with embodiments herein.

FIG. 7 provides a front perspective view of components of a third system, in accordance with embodiments herein.

FIG. 8 is a flowchart of a method, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In one embodiment, the present disclosure relates to a system, comprising a storage compartment configured to hold one or more units each of one or more products, wherein the one or more products are selected from pillows, mattresses, pillowcases, sheets, blankets, or comforters; at least one delivery compartment configured to receive at least one unit and permit extraction of the at least one unit by a user; unit transfer subsystem configured to remove a selected at least one unit from the storage compartment and transfer the selected at least one unit to the delivery compartment; and a user interface configured to display the one or more products to a user, receive a user selection of one or more of the units, and authorize the unit transfer subsystem to transfer the selected at least one unit to the delivery compartment.

Embodiments herein may be utilized as an automated retail point of sale or retail distribution device, such an automated kiosk or vending machine. Embodiments herein present various novel features that allow for detecting consumer input, determining an appropriate product to dispense, acquiring payment, and executing dispensing of the appropriate product. Embodiments also disclose performing data collection, data correlation, and data analysis regarding consumer input, consumer behavior, consumer interests, etc., based on inquiry and/or transaction performed by a consumer.

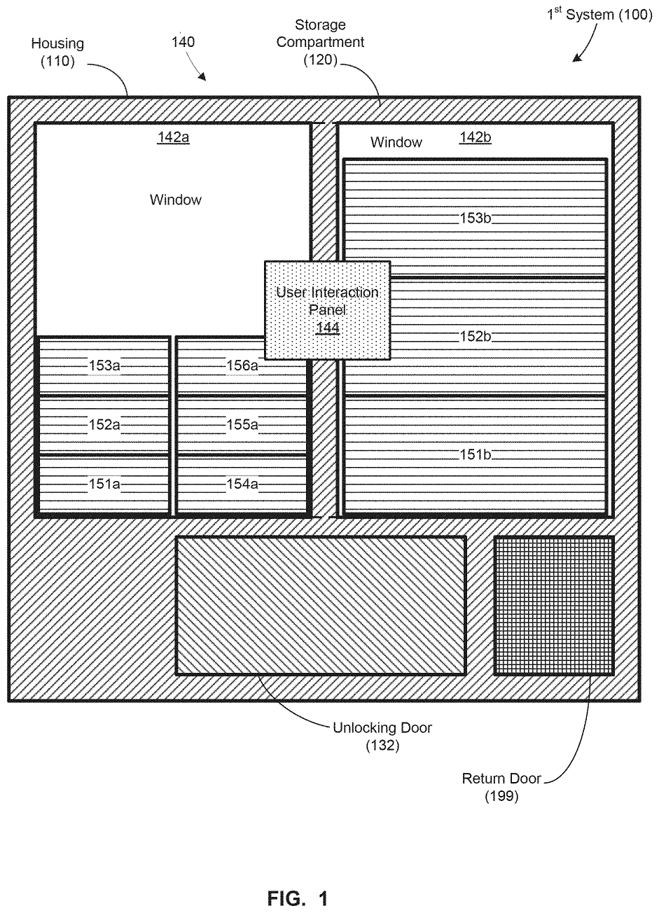

FIG. 1 shows a conceptual front view of components of a first system 100, in accordance with embodiments herein. The components shown are housed in a housing 110. The housing 110 may be formed of metal(s), metal alloy(s), rigid plastic(s), or any other material known to the person of ordinary skill in the art having the benefit of the present disclosure. The housing 110 may comprise text, graphics, speakers, a graphical user interface (GUI), and/or other consumer-facing elements identifying the type(s) of products provided by the system 100, the manufacturer(s) of the product(s), the owner and/or lessee of the system 100, notifications required for regulatory or legal purposes, etc.

The housing 110 is depicted as having a rectangular or approximately square shape in front view. However, the shape of any housing of any components of the system 100 may be varied as a routine matter by the person of ordinary skill in the art having the benefit of the present disclosure.

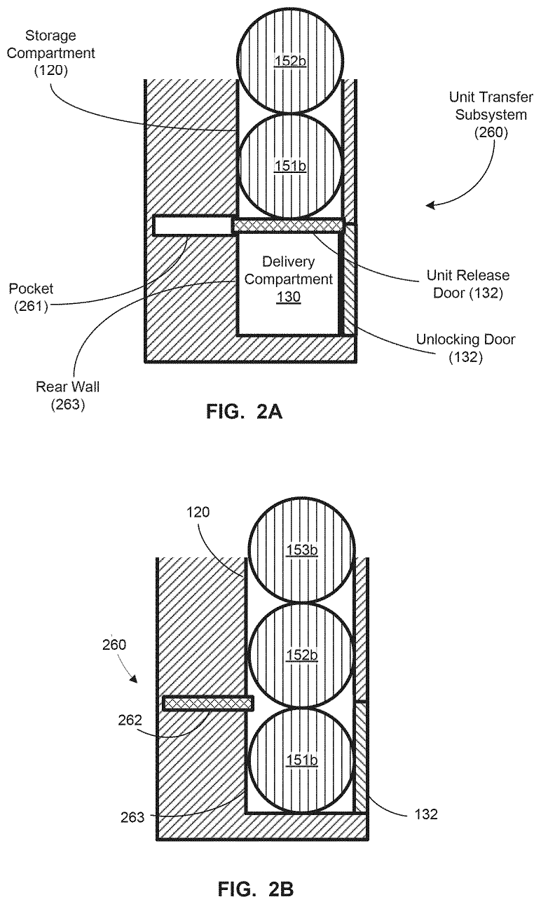

The housing 110 comprises a storage compartment 120. The storage compartment 120 is located in the interior of the housing 110 and is indicated by dashed lines on the front view shown in FIG. 1. FIG. 2A and FIG. 2B show a side view of the storage compartment 120. The storage compartment 120 is configured to hold one or more units 150 each of one or more products indicated by the suffix a or b to the reference numeral of the units 150-159 (collectively “units 150”). For convenience and ease of description, unit(s) may be generically referred to as unit 150 or units 150

In a particular embodiment, the one or more products provided by the system 100 may be sleep-related products, such as pillows, mattresses, pillowcases, sheets, blankets, comforters, etc. In a more particular embodiment, as shown in FIG. 1, the storage compartment 120 may hold units of two products, pillows (a) and mattresses (b). In some embodiments, the units 150 may be packaged in a cylindrical package.

In addition, the storage compartment 120 may be configured to hold one or more other products frequently purchased with or used with pillows, mattresses, pillowcases, sheets, blankets, or comforters. Examples of such other products include, but are not limited to, duvets, sleepwear, loungewear, lingerie, alarm clocks, music players, candles, incense, personal item organizers, and marital aids, among others that will be readily determined by the person of ordinary skill in the art having the benefit of the present disclosure.

Regardless of the types of products, in one embodiment, such as is shown in FIG. 1, the storage compartment 120 may be configured to hold two or more products, wherein a first unit of a first of the two or more products and a second unit of a second of the two or more products differ in one or more of height, width, depth, radius, or another dimension.

FIG. 2A and FIG. 2B illustrate a stylized depiction of the housing 110 of FIG. 1, in accordance with embodiments herein. As can be best seen in FIG. 2A and FIG. 2B, the housing 110 comprises a delivery compartment 130. The delivery compartment 130 is configured to receive at least one unit 150 and permit extraction of the at least one unit by a user. Extraction may be permitted by unlocking door 132 (shown in FIG. 1, FIG. 2A, and FIG. 2B) in response to a verified purchase or authorization to extract the unit 150, among other possibilities, as will be discussed in more detail below.

The housing 110 also comprises a unit transfer subsystem 260 configured to remove a selected at least one unit from the storage compartment and transfer the selected at least one unit to the delivery compartment. FIG. 2A and FIG. 2B show one embodiment, in which the unit transfer subsystem 260 comprises a unit release door 262 at the bottom of the storage compartment 120, which, when closed (FIG. 2A), separates the storage compartment 120 from the delivery compartment 130. The unit transfer subsystem 260 of this embodiment also comprises the rear wall 263 and the door 132 of the delivery compartment 130, which may be considered as inclined planes with an angle of 90°. When the storage compartment door 262 is opened, such as by reversibly sliding into a pocket 261, the lowermost unit (e.g., 151b) in the storage compartment 120 may descend along the inclined planes 263 and/or 132, arriving in the delivery compartment 130. The storage compartment door 262 may then be closed, returning to a conformation (not shown) similar to that of FIG. 2A, differing from FIG. 2A in that the delivery compartment 130 is substantially filled with the unit 151b and unit 152b is now the lowermost unit in the storage compartment 120.

As should be apparent, the unit transfer subsystem 260 is configured to transfer units of all products held in storage compartment 120, even though only one product is shown for ease of illustration in FIG. 2A and FIG. 2B.

The embodiment shown in FIG. 2A and FIG. 2B is exemplary and non-limiting. The unit transfer subsystem may comprise one or more inclined planes with an angle from about 5° to 90°, such as less than 90°. Each of the inclined planes independently may have a fixed angle or an adjustable angle. Further, the unit transfer subsystem may comprise one or more blocks with adjustable positions, such that the block(s) can be raised/lowered, advanced/retracted, etc. to restrict motion of units until the fulfillment of a purchase or an authorized extraction request is received by the system 100. The use of inclined planes may be desirable when the packaged units are cylindrical or spherical.

Alternatively or in addition, the unit transfer subsystem may comprise one or more claws configured to securely grasp a unit 150, wherein the claws are mounted on a traversing apparatus (e.g., or robotic arm) configured to move in one, two, or three dimensions such that the selected unit is transferred from the storage compartment 120 to the delivery compartment 130. This embodiment may also comprise a controller configured to control operation of the traversing apparatus and the claw.

Also alternatively or in addition, the unit transfer subsystem 260 may comprise one or more suction devices configured to securely grip by reversible suction a unit 150, wherein the suction device(s) are mounted on a traversing apparatus configured to move in one, two, or three dimensions such that the selected unit is transferred from the storage compartment 120 to the delivery compartment 130. This embodiment may also comprise a traverse controller configured to control operation of the traversing apparatus and the suction device.

In any embodiment, the unit transfer subsystem 260 may comprise a shock absorber, which at the simplest may be a fluid-filled bag or a cushion upon which a unit 150 may be dropped with the expectation it will not be damaged.

Returning to FIG. 1, the system 100 may comprise a user interface 140 configured to display the one or more products a, b to a user, receive a user selection of one or more of the units 150, and authorize the unit transfer subsystem 260 to transfer the selected at least one unit to the delivery compartment 130.

In one embodiment of the system 100, the user interface 140 may comprise a user interaction panel 144 and a window 142 configured to show to the user at least one unit 150 of each of the one or more products a, b in the storage compartment 120. In the embodiment shown in FIG. 1, the user interface 140 comprises two windows, 142a and 142b.

Although two windows 142a and 142b are shown in FIG. 1, the housing 110 may comprise one window, two windows, three windows, etc. In embodiments wherein the housing 110 comprises more than one window, the windows may be identical in size and shape, such as is shown for windows 142 and 142b in FIG. 1, but multiple windows need not be. The material from which the window(s) 142 may be made is not of particular importance, provided the material is transparent. The selection of the number, size, and shape of the windows may be made as a routine matter by the person of ordinary skill in the art having the benefit of the present disclosure.

In embodiments wherein the housing 110 comprises window(s) 142, the system 100 may further comprise a unit alignment subsystem 370 configured to identify a label on each of the units and to position the units in the storage compartment such that the label is perceptible through the window by the user.

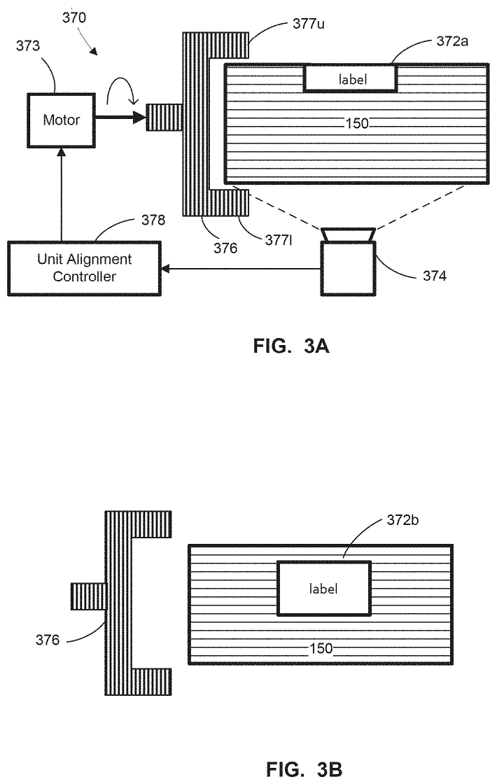

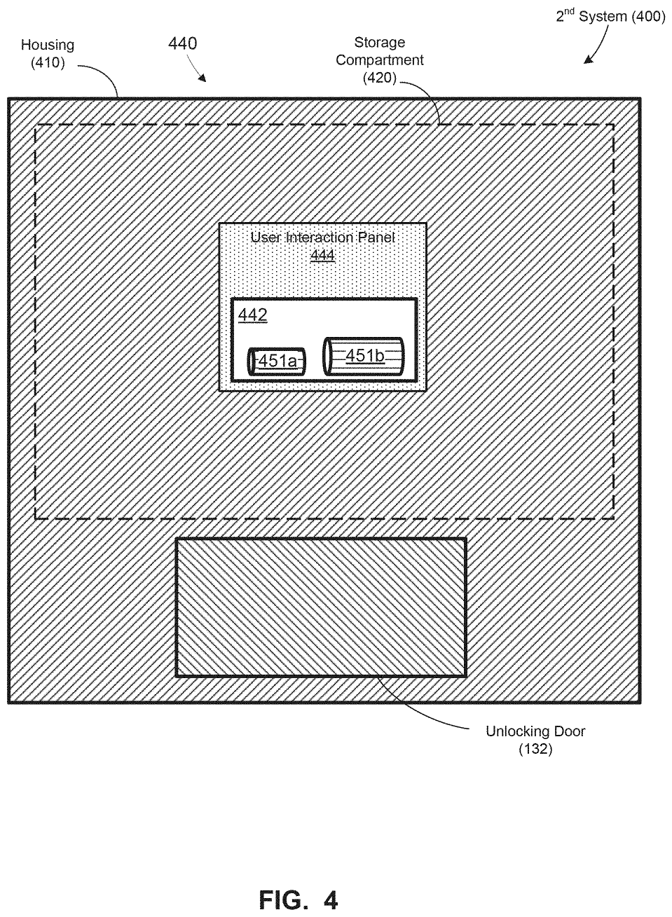

FIG. 3A and FIG. 3B show this embodiment in more detail. A cylindrical unit 151b comprises a label 372. The label 372 is in a conformation a, in which the label is not readable by a user viewing the unit 151b through the window 142b, i.e., a person viewing the unit 151b from substantially the same orientation as the present reader viewing FIG. 3A.

The unit alignment subsystem 370 comprises a camera 374. The camera 374 is configured such that its field-of-view encompasses at least one face of the unit 151b and it receives electromagnetic waves/particles from within its field-of-view. The camera 374 is in communication with a unit alignment controller 378. The unit alignment controller 378 is configured to receive raw or processed photographs, videographs, radio frequency data, etc., from the camera 374 and identify, within the received images or data, an indicator of the position of the label 372. If no indicator is identified, or if the unit alignment controller 378 determines from the indicator that the label 372 is in a conformation a, the unit alignment controller 378 may instruct a motor 373 to move and rotate a unit manipulator 376 to engage with the unit 151b and change the conformation of the unit 151b to a conformation b, in which the label is readable by a user viewing the unit 151b through the window 142b, as represented in FIG. 3B. For example, the unit manipulator 376 may comprise upper and lower flanges 377u and 3771 configured to grip the unit 151b, and the motor 373 may move the unit manipulator 376 such that the flanges 377 are engaged with (FIG. 3A) or disengaged from (FIG. 3B) the unit 151b. When the flanges 377 of the unit manipulator 376 are engaged with the unit 151b, the motor 373 may further rotate the unit manipulator 376 until the label 372 is in the conformation b (FIG. 3B).

Variations of the unit alignment subsystem 370 may be prepared as a routine matter by the person of ordinary skill in the art having the benefit of the present disclosure. For example, rather than comprise two flanges 377u and 3771, the unit manipulator 376 may comprise a circumferential lip. Other unit alignment subsystems may also be routinely prepared, depending on the shape of the unit to be aligned (e.g., sphere, cube, rectangular prism), the space available inside the housing 110 for the unit alignment subsystem, component price, component durability and reliability, esthetic factors (e.g., a desire to surprise a user viewing the unit alignment subsystem in action), etc.

Returning to FIG. 1, the user interface 140 also comprises a user interaction panel 144. The user interaction panel 144 may be mounted on the front of the housing 110; on a side of the housing 110; on a separate stand, platform, kiosk, wall mount, etc. located in proximity to the housing 110; on a separate stand, platform, kiosk, wall mount, etc. located at a location remote from the housing 110, e.g., at a mattress store, bedding store, or the like; may be substituted by a webpage served to a browser on the user's desktop computer, laptop computer, tablet computer, or smartphone; may be substituted by an app downloaded to the user's desktop computer, laptop computer, tablet computer, or smartphone; or two or more thereof. The user interaction panel 144 may comprise one or more interactive elements, e.g., buttons, keypads, sliders, touchscreens, microphones for voice input, etc., along with payment acceptance devices, e.g., cash input slots, coin input slots, change output slots, credit/debit card readers, touchless payment readers, etc., configured for the user to select one or more of the units 150 for purchase or authorized extraction. These operations of the user interface 140 will be discussed in more detail below.

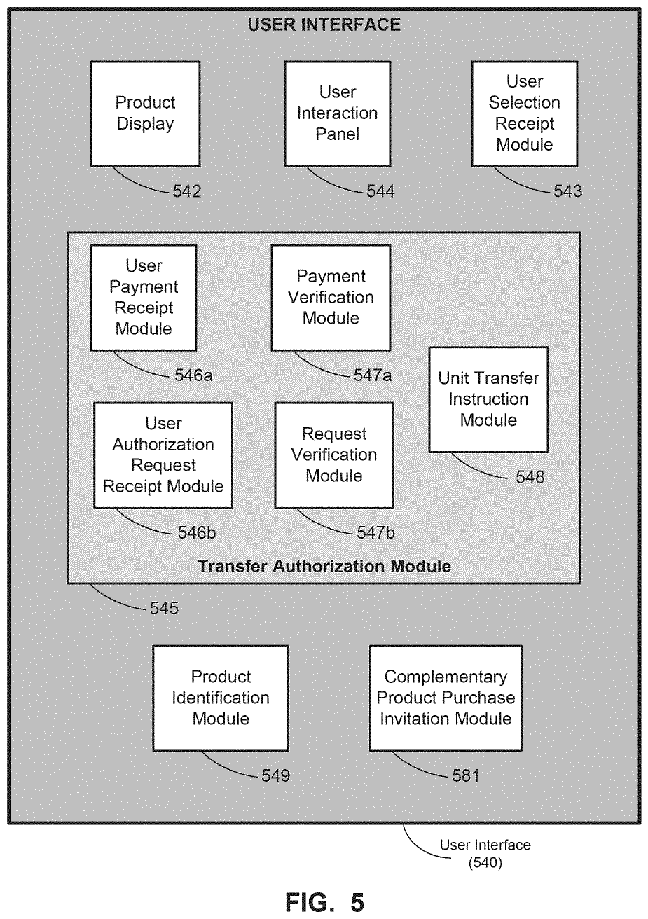

FIG. 4 presents a conceptual front view of components of a second system 400, in accordance with embodiments herein. The second system 400 contains many elements in common with the first system 100. Those common elements will have identical reference numerals between FIG. 1 and FIG. 4. For elements identified by reference numerals “4xx” in FIG. 4, these elements will have numerous similarities by elements identified by reference numerals “lxx” in FIG. 1. For brevity, identical elements in FIG. 4 will not be described again, and for similar elements, the similarities will not be described again. Only dissimilar elements will be described.

The system 400 comprises a housing 410 and a user interface 440. The housing 410 and user interface 440 lack windows. Instead, the user interaction panel 444 comprises a video screen 442. The user interface 440 comprises a video controller (not shown) configured to show to the user, through the video screen 442, a graphical representation of the one or more products in the storage compartment 120, e.g., graphical representation 451a of the first product a, and graphical representation 451b of the second product b. The user interaction panel 444 may comprise any of the user interaction elements of user interaction panel 144. If the video screen 442 is a

FIG. 5 shows a block diagram of components of a user interface 540. The user interface 540 may be equivalent to the user interface 140 shown in FIG. 1, the user interface 440 shown in FIG. 4, or other user interfaces in accordance with embodiments herein.

In FIG. 5, the user interface 540 comprises a product display 542. The product display 542 may be equivalent to the window(s) 142 shown in FIG. 1, the video screen 442 shown in FIG. 4, or other product display technologies in accordance with embodiments herein.

The user interface 540 also comprises a user interaction panel 545. The user interaction panel 544 may comprise any combination of hardware, software, and/or firmware. The user interaction pane 544 may comprise one or more of the user interactive elements described above with reference to user interaction panels 144 and/or 444.

The user interface 540 also comprises a user selection receipt module 543. The user selection receipt module 543 may comprise any combination of hardware, software, and/or firmware. The user selection receipt module 543 is configured to receive input from a user, such as input by way of the user interaction panel 544, and determine the user's selected unit(s) 150, namely, which unit(s) 150 the user wishes to purchase or extract from the housing 110.

The user interface 540 also comprises a transfer authorization module 545. The transfer authorization module 545 may comprise one or more modules, which, working together, configure the transfer authorization module 545 to authorize the transfer of the user's selected unit(s) 150 from the storage compartment 120 to the delivery compartment 130.

The transfer authorization module 545 may comprise a user payment receipt module 546a. The user payment receipt module 546a is configured to receive payment(s) from a user for the purchase of the user's selected unit(s) 150. A payment verification module 547a is configured to determine if each payment is valid, e.g., if a banknote appears to be non-counterfeit, if a credit card is authorized for the amount of the payment, if an account linked to a debit card has sufficient funds to make the payment, etc.

Alternatively or in addition, the transfer authorization module 545 may comprise a user authorization request receipt module 546b. The user authorization request receipt module 546b is configured to receive requests from user (in this case, the purchaser of the selected unit 150 or the purchaser's agent) to recognize that the user is authorized to extract the selected unit 150 from the housing 110.

For example, the user may have purchased the selected unit 150 remotely, e.g., at a dedicated remote location, or through a browser or app on the user's computing device. As part of the remote purchase, the user received a token authorizing extraction of the selected unit 150 from the housing 110. The token may be an alphanumeric code, a QR code, an RFID chip, a physical item, or any other token presentable by the user to the user authorization request receipt module 546b.

For another example, the user may be a delivery driver acting as an agent for extraction of the purchaser's selected unit 150 from the housing 110 and delivery of the selected unit 150 to a location desired by the purchaser. The purchaser may have received the authorization token from the user directly or via an intermediary.

The transfer authorization module 545 may comprise a request verification module 547b configured to determine if each request is valid, e.g., if the token was properly created or transmitted to the user, if the token was previously redeemed for extraction of a selected unit 150, if the token is authenticated by a two-factor authentication process (e.g., if the user must provide the request verification module 547b a verification code sent by text message to the user's phone), etc.

The transfer authorization module 545 may comprise a unit transfer instruction module 548 configured to, upon verification of payment or extraction authorization, instruct the unit transfer subsystem 260 to transfer the selected unit(s) 150 from the storage compartment 120 to the delivery compartment 130. The unit transfer instruction module 548 may also instruct the delivery compartment 130 to allow extraction of the selected unit(s) 150 therefrom, e.g., by unlocking door 132, etc. In other embodiments, the delivery compartment 130 may comprise a monitoring module configure to detect transfer of the selected unit(s) 150 thereinto and subsequently allow extraction. Alternatively, the unit transfer subsystem 260 may comprise a monitoring module configured to detect completion of a transfer process and thereupon instruct the delivery compartment 130 to allow extraction of the selected unit(sa0 150.

In embodiments, the user interface 540 may comprise additional modules, such as product identification module 549. The product identification module 549 is configured to identify a first product(s) (e.g., product a or b) of which the selected unit(s) 150 are instances. This may be useful in inventory management, and may also or instead be useful in conjunction with a complementary product purchase invitation module 581. The complementary product purchase invitation module 581 may be configured to invite the user to purchase a unit of a second product, wherein the second product is complementary to the first product. For example, if the first product is a mattress of a given size and depth, the second product may be a pillow of a matching size; a fitted sheet, a flat sheet, or both matching the size and depth of the mattress; a blanket or comforter matching the size and depth of the mattress; sleepwear, loungewear, or the like; nightstand items; etc.

The invitation may be made at the housing 110, a remote kiosk, through a webpage or app used by the user in the making of the purchase or when requesting authorization to extract the selected unit(s) 150, or to another client at which the user receives communications or information (e.g., a social media webpage or app, an email client, a webmail page, a personalized advertising web app, etc.). The invitation may be sent at the time of purchase, the time of requesting authorization to extract the selected unit(s) 150, the time of unit extraction, at a time when the unit 150 is deployed by the user, or at any time thereafter. The invitation may take the form of a reminder (“Do you need pillows with your new mattress?”), an also-bought (“Customers who bought this model of mattress also bought . . . ”), or a post-purchase follow up (“Enjoying your new mattress? Enjoy it even more with . . . ”), among numerous other possibilities that will occur to the person of ordinary skill in the art having the benefit of the present disclosure.

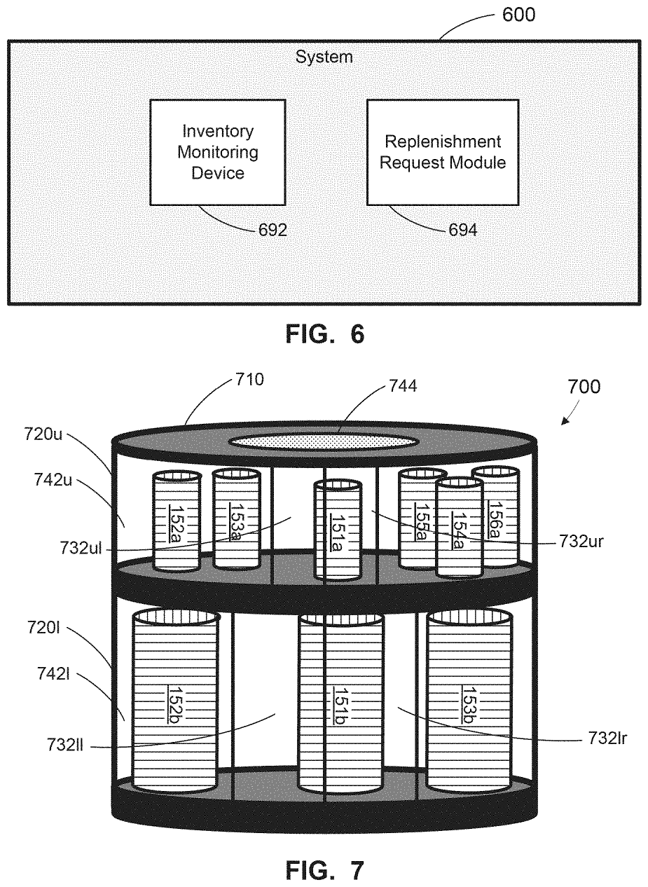

Turning now to FIG. 6, a block diagram of additional components usable in any of the systems described herein (generically, system 600) is shown. In this embodiment, the system 600 further comprises an inventory monitoring device 692. The inventory monitoring device 692 is configured to determine at least one of a number of units 150 of each of the one or more products a, b present in the storage compartment 120, or the rate of transfer of units 150 to the delivery compartment 130 for each of the one or more products a, b present in the storage compartment 120.

In embodiments, the inventory monitoring device 692 may comprise cameras, RFID chip readers configured to detect RFID signals from in the unit 150 and/or the packaging thereof, pressure sensors sensitive to the placement of a unit 150, etc., including two or more thereof, and a controller(s) configured to detect units 150 from data provided by the cameras, RFID chip readers, etc. and to log transfers of units 150 from the storage compartment 120 to the delivery compartment 150. In part or in whole from the time of and the number of units 150 transferred in each logged transfer, the inventory monitoring device 692 may determine the rate of transfer. In embodiments, the rate of transfer of units 150 may be determined at least in part by transfers logged by other systems owned, leased, or operated by the same business entity as the system 600. In one embodiment, such transfers logged by other systems may be loaded into a memory or storage device of the system 600 and/or the inventory monitoring device 692, such as wireless and/or wired data transfer over a public network, a private network, or a virtual private network (VPN), loading from an external data storage device, etc. The transfers logged by other systems may be loaded on a real-time basis, a near-real-time basis, periodically during use of the other systems, and/or after a sample of transfers believed to be representative of expected use patterns of the systems have been logged by the other systems, among other possibilities.

The system 600, as shown in FIG. 6, may also comprise a replenishment request module 694. The replenishment request module 694 is configured to communicate to an operator of the system 600 a request to load one or more units 150 of the one or more products into the storage compartment, in response to the inventory monitoring device 692 determining that the number of units 150 of the one or more products a, b is below a first threshold, the rate of transfer is expected to reduce the number of units 150 of the one or more products a, b to zero within a first timeframe, or both. Desirably, the first threshold may be sufficiently greater than zero and/or the first timeframe may be sufficiently long that the operator may receive the communication in time to replenish the supply of the product(s) in the storage compartment 120 before the storage compartment 120 is emptied of the product(s). Determining the exact value of the first threshold and the exact duration of the first timeframe is a routine optimization for the person of ordinary skill in the art having the benefit of the present disclosure.

Turning back to FIG. 1, in another embodiment, the system 100 may further comprise a unit return compartment (represented by a return door 199) configured to receive a previously extracted unit from the user and identify at least one of a product or a condition of the previously extracted unit, upon receipt of an instruction. In this embodiment, the user interface 140 may be further configured to receive a user request to initiate a refund or exchange for the previously extracted unit; instruct the unit return compartment to perform the reception and identification; and complete the refund or exchange if the identified product matches a prior record of the product of the previously extracted unit, if the condition of the previously extracted unit satisfies one or more quality standards, or both. The user interface 140 may be further configured to decline the refund or exchange, and return the previously extracted unit to the user, if the unit return compartment determines that the product type of the previously extracted unit does not match the user's, a payment processor's, and/or the system 100's owner's, operator's, and/or lessee's records of a prior transaction; if the condition of the previously extracted unit shows signs of damage or attempted fraud, etc.

Variations in the systems 100, 400 shown in FIG. 1 and FIG. 4 may be affected as a routine matter by the person of ordinary skill in the art having the benefit of the present disclosure. For example, the system 100 or 400 may comprise a plurality of delivery compartments (not shown). Alternatively or in addition, if the system 100 or 400 is to be configured to receive returns, one or more delivery compartments 130 may be configured to perform unit return functions as described above.

FIG. 7 provides a front perspective view of components of a third system 700, in accordance with embodiments herein. The third system 700 contains many elements in common with the first system 100. Those common elements will have identical reference numerals between FIG. 1 and FIG. 7. For elements identified by reference numerals “7xx” in FIG. 7, these elements will have numerous similarities by elements identified by reference numerals “lxx” in FIG. 1. For brevity, identical elements in FIG. 7 will not be described again, and for similar elements, the similarities will not be described again. Only dissimilar elements will be described.

As shown in FIG. 7, the system 700 may comprise a cylindrical housing 710. The dimensions of the cylindrical housing 710 are not critical. In one embodiment, the top of the cylindrical housing 710 is from about 5th percentile female elbow height to about 95th male elbow height above a bottom of the cylindrical housing 710. (Height percentiles may be based on anthropometric data from the region in which the housing 710 is to be deployed, in which the housing 710 is manufactured, or standard North American anthropometric data).

Alternatively or in addition, the user interface 140 is configured to receive the user selection via one or more user input elements positioned on the top of the cylindrical housing, e.g. user interaction panel 744.

The cylindrical housing 710 comprises a rotatable upper storage compartment 720u configured to hold one or more units of a first product (e.g., units 151-156 of product a), and a rotatable lower storage compartment 7201 configured to hold one or more units of a second product (e.g., units 151-153 of product b). In the depicted embodiment, the first product is selected from pillows, pillowcases, or sheets, and the second product is selected from mattresses, blankets, or comforters. More generally, the first product stored in the upper storage compartment 720u may be smaller than the second product stored in the upper storage compartment 7201.

The system 700 also comprises an upper delivery compartment (e.g., a compartment defined in part by doors 732ul and 732ur) configured to receive at least one unit 150 of the first product a and permit extraction of the at least one unit 150 of the first product a by a user. The system 700 also comprises a lower delivery compartment (e.g., a compartment defined in part by doors 73211 and 7321r) configured to receive at least one unit 150 of the second product b and permit extraction of the at least one unit 150 of the second product b by the user.

The system 700 also comprises an upper motor configured to rotate the upper storage compartment 720u to position a selected at least one unit 150 from the upper storage compartment 720u in the upper delivery compartment; and a lower motor configured to rotate the lower storage compartment 7201 to position a selected at least one unit 150 from the lower storage compartment 7201 in the lower delivery compartment.

The delivery compartments may comprise various other components in various embodiments. Not shown are security doors which could be lowered from the ceiling of the storage compartment 720 prior to opening of delivery doors 732, thereby preventing theft of units 150 inside the storage compartment 720 when the user extracts the selected and purchased/authorized unit 150 from the delivery compartment. Other security mechanisms are possible and can be implemented as a routine matter by the person of ordinary skill in the art having the benefit of the present disclosure.

Although two delivery compartments, one upper and one lower, are described above, in embodiments, the two delivery compartments may share particular components. In one embodiment, the housing 710 may comprise a central elevator shaft running from the bottom to the top of the housing 710. The elevator shaft may have a door openable to each storage compartment 720. The delivery compartments may comprise volumes within each storage compartment 720 positioned in front of the doors in the elevator shaft, and the delivery compartments may comprise impellors configured to push a selected unit 150 through the door of the elevator shaft (when opened). The elevator may then operate to raise the selected unit to roughly the height of the top of the unit. (In such an embodiment, the user interaction panel 744 would not be positioned over the center of the top of the housing 710, in contrast to the embodiment depicted in FIG. 7).

As shown in FIG. 7, the user interface 140 of system 700 comprises an upper window 742u configured to show to the user at least one unit 150 of the first product a in the upper storage compartment 720u, and a lower window 7421 configured to show to the user at least one unit 150 of the second product b in the lower storage compartment 7201.

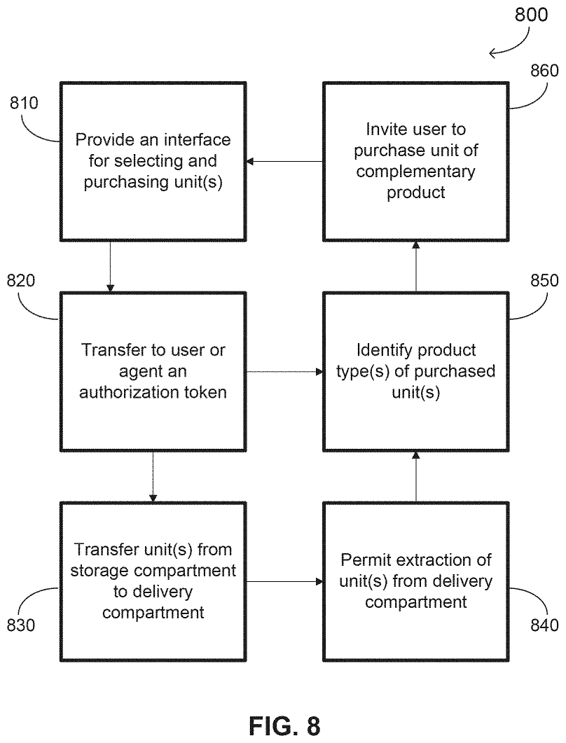

FIG. 8 is a flowchart of a method 800, in accordance with embodiments herein. The method 800 comprises providing (at 810), to a user, an interface for selecting and purchasing one or more units each of one or more products selected from pillows, mattresses, pillowcases, sheets, blankets, or comforters. At 820, the method 800 comprises transferring, to the user or an agent of the user, an authorization token indicative of the user's selection and purchase of the one or more units.

The method 800 also comprises transferring (at 830), by a unit transfer subsystem, the one or more units from a storage compartment configured to hold the one or more units to at least one delivery compartment configured to receive the one or more units. The method 800 additionally comprises permitting (at 840) extraction of the at least one unit from the delivery compartment by a holder of the authorization token (e.g., the purchaser of the unit or an agent of the purchaser delegated to extract the unit and deliver it to the purchaser).

In one embodiment, the method 800 may further comprise identifying (at 850) a first product of the one or more units selected and purchased by the user. The method 800 may additionally comprise inviting (at 860) the user to purchase a unit of a second product, wherein the second product is complementary to the first product.
101. In one embodiment, the present invention comprises a system comprising: a cylindrical housing, comprising a rotatable upper storage compartment configured to hold one or more units of a first product, and a rotatable lower storage compartment configured to hold one or more units of a second product, wherein the first product is selected from pillows, pillowcases, or sheets, and the second product is selected from mattresses, blankets, or comforters; an upper delivery compartment configured to receive at least one unit of the first product and permit extraction of the at least one unit of the first product by a user; a lower delivery compartment configured to receive at least one unit of the second product and permit extraction of the at least one unit of the second product by the user; an upper motor configured to rotate the upper storage compartment to position a selected at least one unit from the upper storage compartment in the upper delivery compartment; a lower motor configured to rotate the lower storage compartment to position a selected at least one unit from the lower storage compartment in the lower delivery compartment; and a user interface configured to display the one or more products to a user, receive a user selection of one or more of the units, and authorize the unit transfer subsystem to transfer the selected at least one unit to the delivery compartment.
102. The system of claim 102, wherein a top of the cylindrical housing is from about 5th percentile female elbow height to about 95th male elbow height above a bottom of the cylindrical housing; and the user interface is configured to receive the user selection via one or more user input elements positioned on the top of the cylindrical housing.
103. Embodiments herein also comprise a method, comprising: providing, to a user, an interface for selecting and purchasing one or more units each of one or more products selected from pillows, mattresses, pillowcases, sheets, blankets, or comforters; transferring, to the user or an agent of the user, an authorization token indicative of the user's selection and purchase of the one or more units; transferring, by unit transfer subsystem, the one or more units from a storage compartment configured to hold the one or more units to at least one delivery compartment configured to receive the at least one unit; and permitting extraction of the at least one unit by a holder of the authorization token.
104. The method of claim 103, further comprising: identifying a first product of the one or more units selected and purchased by the user; and inviting the user to purchase a unit of a second product, wherein the second product is complementary to the first product.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A system, comprising:
a storage compartment configured to hold one or more units each of one or more products, wherein the one or more products are selected from pillows, mattresses, pillowcases, sheets, blankets, or comforters;
at least one delivery compartment configured to receive at least one unit and permit extraction of the at least one unit by a user;
a unit transfer subsystem configured to remove a selected at least one unit from the storage compartment and transfer the selected at least one unit to the delivery compartment; and
a user interface configured to display the one or more products to a user, receive a user selection of one or more of the units, and authorize the unit transfer subsystem to transfer the selected at least one unit to the delivery compartment.

2. The system of claim 1, wherein:
the user interface comprises a window configured to show to the user at least one unit of each of the one or more products in the storage compartment.

3. The system of claim 2, further comprising:
a unit alignment subsystem configured to identify a label on each of the units and to position the units in the storage compartment such that the label is perceptible through the window by the user.

4. The system of claim 1, wherein:
the user interface comprises a video screen and a video controller, wherein the video controller is configured to show to the user a graphical representation of the one or more products in the storage compartment.

5. The system of claim 1, wherein the storage compartment is configured to hold two or more products, wherein a first unit of a first of the two or more products and a second unit of a second of the two or more products differ in one or more of height, width, depth, radius, or another dimension.

6. The system of claim 1, wherein the unit transfer subsystem comprise an inclined plane with an angle from about 5° to 90°.

7. The system of claim 1, wherein the user interface is configured to authorize the transfer of the selected at least one unit to the delivery compartment by a) receiving a payment from the user, b) verifying the payment, and c) instructing the unit transfer subsystem to transfer the selected at least one unit in response to the payment being verified as valid.

8. The system of claim 1, wherein the user interface is configured to authorize the transfer of the selected at least one unit to the delivery compartment by a) receiving an authorization request from the user, b) verifying the request, and c) instructing the unit transfer subsystem to transfer the selected at least one unit in response to the request being verified as valid.

9. The system of claim 1, further comprising:
an inventory monitoring device configured to determine at least one of a number of units of each of the one or more products present in the storage compartment or rate of transfer of units to the delivery compartment for each of the one or more products present in the storage compartment; and
a replenishment request module configured to communicate to an operator a request to load one or more units of the one or more products into the storage compartment, in response to the inventory monitoring device determining that the number of units of the one or more products is below a first threshold, the rate of transfer is expected to reduce the number of units of the one or more products to zero within a first timeframe, or both.

10. The system of claim 1, wherein the user interface is further configured to identify a first product of the unit selected by the user, and invite the user to purchase a unit of a second product, wherein the second product is complementary to the first product.

11. The system of claim 1, further comprising:
a unit return compartment configured to receive a previously extracted unit from the user and identify at least one of a product or a condition of the previously extracted unit, upon receipt of an instruction;
wherein the user interface is further configured to receive a user request to initiate a refund or exchange for the previously extracted unit; instruct the unit return compartment to perform the reception and identification; and complete the refund or exchange if the identified product matches a prior record of the product of the previously extracted unit, if the condition of the previously extracted unit satisfies one or more quality standards, or both.

12. A system, comprising:
a cylindrical housing, comprising a rotatable upper storage compartment configured to hold one or more units of a first product, and a rotatable lower storage compartment configured to hold one or more units of a second product, wherein the first product is selected from pillows, pillowcases, or sheets, and the second product is selected from mattresses, blankets, or comforters;
an upper delivery compartment configured to receive at least one unit of the first product and permit extraction of the at least one unit of the first product by a user;
a lower delivery compartment configured to receive at least one unit of the second product and permit extraction of the at least one unit of the second product by the user;
an upper motor configured to rotate the upper storage compartment to position a selected at least one unit from the upper storage compartment in the upper delivery compartment;
a lower motor configured to rotate the lower storage compartment to position a selected at least one unit from the lower storage compartment in the lower delivery compartment; and
a user interface configured to display the one or more products to a user, receive a user selection of one or more of the units, and authorize the unit transfer subsystem to transfer the selected at least one unit to the delivery compartment.

13. The system of claim 12, wherein:
the user interface comprises an upper window configured to show to the user at least one unit of the first product in the upper storage compartment and a lower window configured to show to the user at least one unit of the second product in the lower storage compartment.

14. The system of claim 13, further comprising:
an upper unit alignment subsystem configured to identify a label on each of the units of the first product and to position the units in the upper storage compartment such that the label is perceptible through the upper window by the user; and
a lower unit alignment subsystem configured to identify a label on each of the units of the second product and to position the units in the lower storage compartment such that the label is perceptible through the lower window by the user.

15. The system of claim 12, wherein:
the user interface comprises a video screen and a video controller, wherein the video controller is configured to show to the user a graphical representation of the one or more products in the storage compartment.

16. The system of claim 12, wherein the user interface is configured to authorize the transfer of the selected at least one unit to the upper or lower delivery compartment by a) receiving a payment from the user, b) verifying the payment, and c) instructing the unit transfer subsystem to transfer the selected at least one unit in response to the payment being verified as valid.

17. The system of claim 12, wherein the user interface is configured to authorize the transfer of the selected at least one unit to the upper or lower delivery compartment by a) receiving an authorization request from the user, b) verifying the request, and c) instructing the unit transfer subsystem to transfer the selected at least one unit in response to the request being verified as valid.

18. The system of claim 12, further comprising:
an inventory monitoring device configured to determine at least one of a number of units of at least one of the first and second products present in the upper and lower storage compartments, or a rate of transfer of units of at least one of the first and second products to the upper or lower delivery compartment from the upper or lower storage compartment; and
a replenishment request module configured to communicate to an operator a request to load one or more units of the first or second products into the upper or lower storage compartment, in response to the inventory monitoring device determining that the number of units of the first product is below a first threshold, the number of units of the second product is below a second threshold, the rate of transfer of units of the first product is expected to reduce the number of units of the first product in the upper storage compartment to zero within a first timeframe, the rate of transfer of units of the second product is expected to reduce the number of units of the second product in the lower storage compartment to zero within a second timeframe, or two or more thereof.

19. The system of claim 12, wherein the user interface is further configured to identify a first product of the unit transferred to the delivery device, and invite the user to purchase a unit of a second product, wherein the second product is complementary to the first product.

20. The system of claim 12, further comprising:
a unit return compartment configured to receive a previously extracted unit from the user and identify at least one of a product or a condition of the previously extracted unit, upon receipt of an instruction;
wherein the user interface is further configured to receive a user request to initiate a refund or exchange for the previously extracted unit; instruct the unit return compartment to perform the reception and identification; and complete the refund or exchange if the identified product matches a prior record of the product of the previously extracted unit, if the condition of the previously extracted unit satisfies one or more quality standards, or both.
